(19) United States
(12) Patent Application Publication
(10) Pub. No.: US 2021/0383305 A1
(43) Pub. Date: Dec. 9, 2021

(54) NPT SCORE

(71) Applicant: Osman Yusuf, HOLLYWOOD PARK, TX (US)

(72) Inventor: Osman Yusuf, HOLLYWOOD PARK, TX (US)

(21) Appl. No.: 16/891,227

(22) Filed: Jun. 3, 2020

(51) Int. Cl. G06Q 10/06

(52) U.S. Cl. CPC G06Q 10/06398; G06Q 10/063114

(57) ABSTRACT

A method for scoring contractor operational performance. The scores being based on predetermined and subsequent actual times for various productive and non-productive times. Further, the performance scoring network provides one or more portals for users to view and evaluate the scores of the one or more contractors.

### BACKGROUND

This section is intended to introduce the reader to aspects of art that may be related to various aspects of the present invention or present solution, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Generally, companies (employers) employing contractors want to hire contractors who are the most safe, efficient, reliable, and cost effective for a particular project, contract, assignment, job, task, or duty for which the contractor is being hired. This is particularly true in the oil and gas industry where there exists substantial contracting and employing of service contractors by oil and gas companies with tremendous financial, health and environmental risks in a particular contract or project. Currently, there is no operational performance score for contractors. Here, employers generally have to rely on the contractor's own account and records for their own performance, which poses obvious conflicts of interest. This contractor supplied performance data is self-governed and therefore seldom negative and typically untrustworthy. This not only prevents employers from accurately vetting a potential contractor but consequentially creates an environment of mediocre results and potentially dangerous outcomes as poor performance goes unchecked and lessons are not learned or shared and simply forgotten. Other times, the employing company may need to seek out and find prior employers who have previously hired the contractor to determine a contractor's performance and efficiency. Hence, the aforementioned drawbacks of not knowing and/or not being able to verify either in a timely manner or at all, a contractor's operational performance, creates a great financial risk and uncertainty for an employing company thus requiring even more time to complete proper vetting and due diligence on one or more contractors, which in some cases is simply impossible to complete prior to the project's commencement date.

Hence, what is needed is a method for scoring contractor operational performance which is unbiased, simple and results in a clear score.

### BRIEF SUMMARY OF THE INVENTION

The present invention addresses the deficiencies and shortfalls of the aforementioned systems and methods. Particularly, in one aspect of the present invention, a method for scoring various types of contractors and service providers operations. Specifically, a program is provided that can be accessed via a computer, tablet, and/or mobile phone, and is used for scoring various types of contractors and service providers operations.

The above summary is not intended to describe each and every disclosed embodiment, aspect, or every implementation of the present invention or disclosure. The description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates an overview diagram of communication between a central server and multiple terminals according to one non-limiting embodiment of the present invention.

FIG. 2 illustrates an overview diagram of various components, modules, and databases within a central server in communication with one or more portals and sources according to one non-limiting embodiment of the present invention.

FIG. 3 illustrates a flow chart diagram for a login process according to one non-limiting embodiment of the present invention.

FIG. 4 illustrates a flow chart diagram for a contractor portal process according to one non-limiting embodiment of the present invention.

FIG. 5 illustrates a flow chart diagram for an employer portal process according to one non-limiting embodiment of the present invention.

FIG. 6 illustrates a flow chart diagram for an operator portal process according to one non-limiting embodiment of the present invention.

### DETAILED DESCRIPTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

In one embodiment of the present invention, a computer, desktop, mobile, or tablet software and application are disclosed for scoring contractor performance. Various aspects of the invention described herein may be applied to any of the particular applications set forth below or for any other types of user interfaces and video displays. An embodiment of the invention may be applied as a standalone system or method, or as part of an integrated software package, such as a service management and/or data management package or application. It shall be understood that different aspects of the invention can be appreciated individually, collectively, or in combination with each other.

In one embodiment of the invention, the employer will assign a predetermined time expectation for a specific operation. Once the contractor completes the actual operation the total time will be recorded and mutually agreed upon. Also, any non-productive time will also be recorded and mutually agreed upon.

In another embodiment of the invention, the scoring program has the capability to allow employer and contractor parties to mutually agree on time and other data.

In one implementation of the invention, a display page may include information residing in the computing device's memory, which may be transmitted from the computing device over a network to a central database center and vice versa. The information may be stored in memory at each of the computing device, a data storage resided at the edge of the network, or on the servers at the central database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., an iPhone®, Android®, Blackberry®, or any ‘smart phone’), a personal computer, iPad®, server computer, or laptop computer; personal digital assistants (PDAs) such as a Palm-based device or Windows® CE device; a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices.

On a computing or mobile device, the display page may be interpreted by software residing on a memory of the device, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Any computer readable media with logic, code, data, instructions, may be used to implement any software or process flow or steps or methodology. Where a network comprises the Internet, a display page may comprise a webpage of a type known in the art.

A display page according to the invention may include embedded functions comprising software programs stored on a memory, for example, Cocoa, VBScript routines, JScript routines, JavaScript routines, Java applets, ActiveX components, ASP.NET, AJAX, PHP, Flash applets, Silverlight applets, or AIR routines. A display page may comprise well-known features of graphical user interface technology, for example, frames, windows, tabs, scroll bars, buttons, icons, menus, fields, and hyperlinks, and well-known features such as a touchscreen interface. Pointing to and touching on a graphical user interface button, link, icon, menu option, or hyperlink also is known as “selecting” the button, link, icon, option, or hyperlink. Additionally, a “point and gesture” interface may be utilized, such as a hand-gesture driven interface. Any other interface for interacting with a graphical user interface may be utilized, such as haptic feedback interfaces. A display page according to the invention also may incorporate multimedia features.

Phrases and terms similar to “software”, “application”, and “firmware” may include any non-transitory computer readable medium storing thereon a program, which when executed by a computer, causes the computer to perform a method or function.

Phrases and terms similar “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Phrases and terms similar to “portal” may include an intranet page, internet page, locally residing software or application, or digital presentation for a user of the scoring program. The portal may also be any graphical user interface for accessing various modules, features, options, and/or attributes of the present invention. For example, the portal can be a web page accessed with a web browser, mobile device application, or any application or software residing on a computing device.

Phrases and terms similar to “contractor” may include any type of person or entity, service provider, job candidate, contractor, sub-contractor, worker, or employee that can access the contractor, sub-contractor, job candidate, personnel, or employee and administrator capabilities of the scoring program.

Phrases and terms similar to “employer” may include any type of person, manager, officer, member, client, owner, principal, and/or agent of any type of business, company, entity, and/or organization, that can access the employer and employer administrative capabilities of the scoring program.

Phrases and terms similar to “operator” may include any type of person, service provider, job candidate, contractor, sub-contractor, worker, or employee that can access the contractor, sub-contractor, job candidate, personnel, or employee and administrator capabilities of the scoring program.

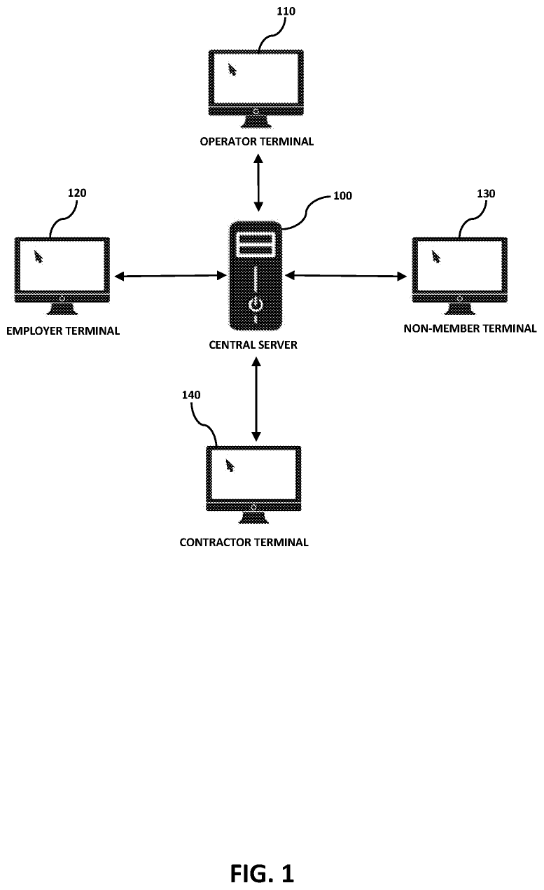

FIG. 1 illustrates an overview diagram of one non-limiting embodiment of a network system for the performance scoring network system and method of the present invention. Specifically, the performance scoring network system and method can include one or more central servers 100 in bi-directional communication over a wired or wireless network with one or more terminals, clients, or portals, including but not limited to operator terminals 110, employer terminals 120, non-member terminals 130, and contractor terminals 140. Here, terminals 110-140 can have various access levels, privileges, and functionalities within the performance scoring network. It is contemplated within the scope of the invention that there may be any number of terminals or clients having various access privileges and functionalities within the performance scoring network.

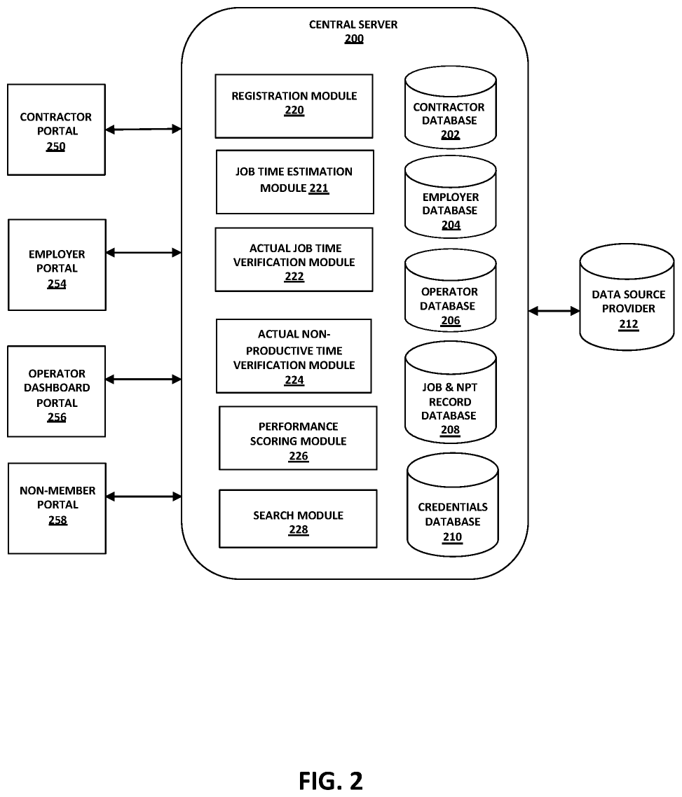

FIG. 2 illustrates an overview of various components, modules, and databases within a central server in communication with one or more portals and sources according to one non-limiting embodiment of the present invention. Specifically, in one embodiment, the performance scoring network system and method can include a central server 200 in bi-directional communication over a wired or wireless network with one or more contractor portal 250, employer portal 254, operator dashboard portal 256, non-member portal 258, and one or more data source providers 212. Here, central server 200 can include one or more databases including but not limited to contractor database 202, employer database 204, operator database 206, job and NPT record database 208, and credentials database 210. The central server 200 can further include one or more modules including but not limited to registration module 220, job time estimation module 221, actual job time verification module 222, actual job non-productive time verification module 224, performance scoring module 226, and search module 228.

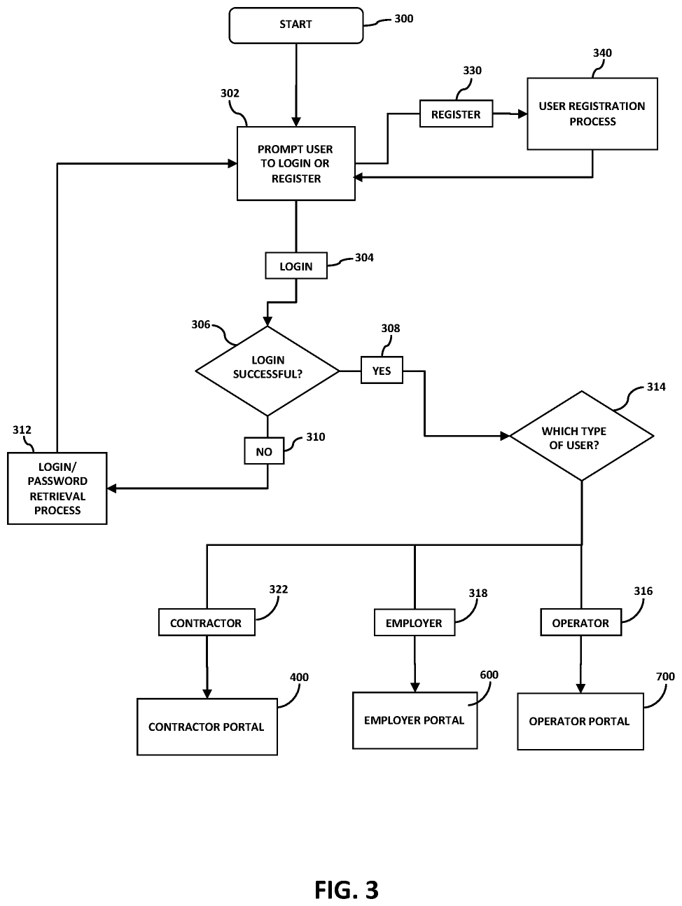

FIG. 3 illustrates flow chart for a login process according to one non-limiting embodiment of the present invention. Here, the process starts at step 300, wherein a user can visit an online web portal, application, or intranet portal and be prompted to login or register at step 302. If a new user is accessing the website, they will want to register by selecting a registration element or link 330 within the portal that will lead them to the registration process at step 340 to register with the performance scoring network system and method. At the registration process 340, the user will be prompted to register or create a profile, by providing data or information including but not limited to: personal information, account information, securing information, full name, date of birth, username, email address, password, security question, and security question hint or answer. Further, at the registration process 340, the user can select if they are using performance scoring network as a contractor, employer, or operator. Alternatively, in some embodiments, a user can bypass the registration process and access various functionalities of the performance scoring network as a non-member user, such as viewing (or interacting with) the profiles, ratings, grading, scoring, job record, and/or credentials of contractors, personnel, sub-contractor, and/or employees. Alternatively, the non-member user can view (or interact with) a list or profiles of employers or contractors that are part of the performance scoring network.

Once a user has successfully registered with the Performance scoring network, the system can assign a unique identification code or number to that user. The user can be prompted to login again at step 302. Here, the user can enter their credentials, such as username and/or password in order to be authenticated and to access the performance scoring network. Alternatively, the user can authenticate themselves via one or more social networks (e.g. Facebook®, Google+®, LinkedIn®, or the like) or the user can be authenticated via fingerprint, gesture, pattern, or passcode. It is further contemplated within the scope of the invention that the Performance scoring network can be integrated or be part of a social network (e.g. Facebook®, Google+®, LinkedIn®, or the like). Once the user has entered their login credentials at step 304, the Performance scoring network will determine if the login or user authentication was successful at step 306. If the login or authentication is not successful, then at step 310 the user will be directed to a login/password or authentication retrieval process at step 312. At the login/password retrieval process 312, the user may be provided with security questions and other login, credential, or password related hints or data in order for the user to retrieve their login information. Once the user has retrieved their login or credential information, then they will be re-directed back to the login process at step 302.

If the login is successful at step 308, then the performance scoring network will determine what type of user (such as contractor, employer, operator, or non-member) is accessing the system at step 314. Here, the performance scoring network will grant certain access privileges to the system depending on which type of user is accessing the performance scoring network. Alternatively, at step 314, the user can be prompted to select which type of user they are accessing the system as (i.e. contractor, contractor admin, employer, operator, or non-member). Referring back to FIG. 3, once the Performance scoring network determines which type of user (contractor 322, employer 318, or operator 316) is accessing the system, then the process will direct the user to the appropriate portal or page, such as the contractor portal 400, employer portal 600, or operator portal 700. It is contemplated within the scope of the invention that there may be any number or different types of portal in addition to or in lieu of the aforementioned portals, such as a personnel portal, sub-contractor portal, non-member portal, licensee/licensor portal, trial member portal, member portal, or the like.

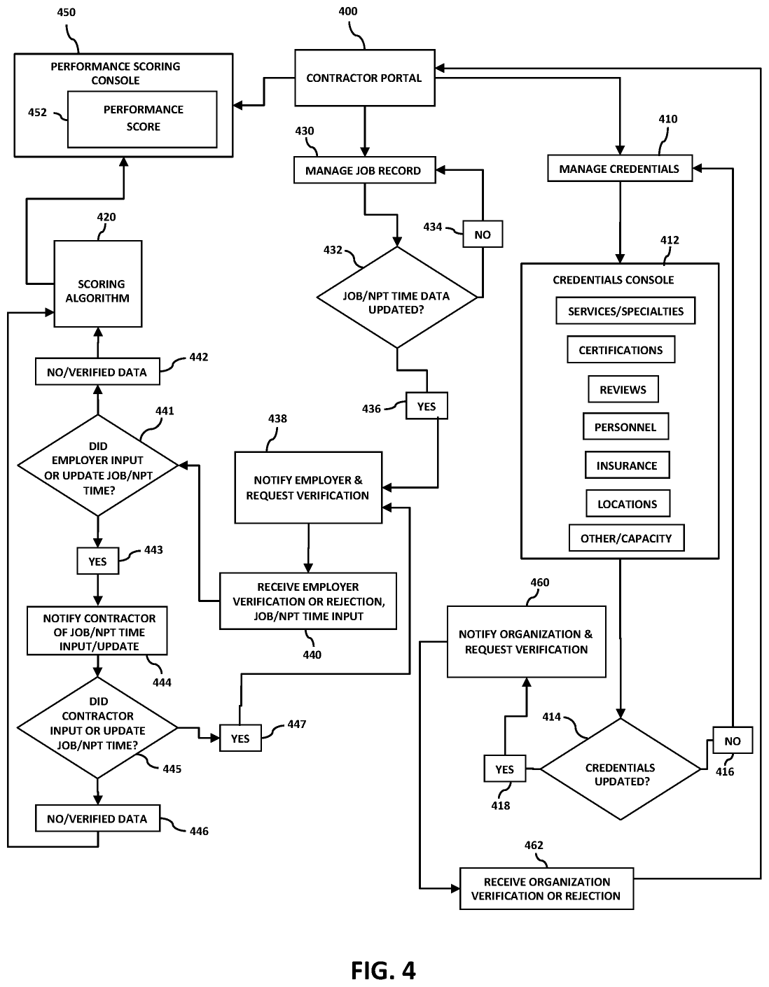

Referring now to FIG. 4, if the user is logged in as a contractor, then they will be directed to contractor portal 400. Here, the user (contractor) will be provided with a plurality of components/options and/or modules to select from, including but not limited to managing job record module 430, and/or accessing NPT or performance scoring console or module 450. If the user selects the managing credentials module 410, then they will be presented with a credentials console or module 412 having one or more sub-modules pertaining to the contractor's credentials. These sub-modules can include a services/specialties module that can allow the contractor to add, delete, and/or edit information pertaining to the services they offer and their specialties. This can also include information on their personnel, such as highest level of competency, education, high school, university, community college, technical school, classes, courses, degrees earned, major/minor, publications, activities, athletics, associations, internships, affiliations, etc. Certification module will allow the user/contractor to add, delete, and/or edit their company's training/instruction/guidance information, such as training certifications, licensures, licensures from governing associations, security clearances, courses, training completions, training level, specialized training education, training classes, training guides, specialized skills, type of training, length of training, physical assessment, videos, photos, and/or interactive data. For example, in the oil and gas industry, some but not all governing associations that can be included in the certifications module include API (American Petroleum Institute), IADC (International Association of Drilling Contractors), ISO (International Organization of Standardization), OSHA (Occupational Safety and Health Administration), DNV (Det Norske Veritas), and Achilles.

Still referring to module 412 of FIG. 4, a Reviews module can allow the user to add, delete, and/or comment, edit, or allow employer's or third parties to view the contractor's prior reviews or feedback from past or current clients or employers. A Personnel module will allow the user to add, delete, and/or edit personnel or employee(s), including any pertinent information related to the personnel or employee(s), including but not limited to: profile, resume, credentials, education, experience, training, certifications, licensures, medical history, medical/health information, medical/health assessment, physical/mental assessment, photos, videos, interactive data, offshore survival training and certification data, and the like. The Insurance module can allow the user to add, delete, and/or edit one or more of their insurers, liability amounts, and/or insurance coverage data. The Locations module can allow the user to add, delete, and/or edit one or more locations that the user is located or at or geographic locations or areas that the user/contractor can serve or provide services. The Other/Capacity module can allow the user to add, delete, and/or edit any additional information about themselves or their company, such as scheduling data, capacity to perform certain services, tool inventory and availability, personnel levels and availability, and the like.

Still referring to FIG. 4, once the user leaves credentials console 412, the process will determine at step 414 if any of the aforementioned modules within credentials console 412 were added, deleted, and/or edited. If the credentials were not modified, then at step 416 the process will redirect the user back to the manage credentials module 410 or contractor portal 400. If the modules within credentials console 412 were modified, then at step 418 the process can send and/or or notify the updated/modified credentials data to an employer or organization and request verification 460. Here, an organization can be one or more of a company, committee, board, agency, employer, accreditation institution or agency, certification institution, educational institution, university, college, secondary school, high school, technical school, licensure organization, state/local/federal regulatory organization or agency, and the like. Furthermore, the organization can have an entity, agent(s), and/or individuals responsible for verifying the contractor's credentials data. For example, if the organization is a licensure agency or university, an administrator or registrar at the university or can verify if one or more personnel of the user/company did indeed attend and/or obtain a license from the university or an institution. Here, the notification or verification request can be sent from within the Performance scoring network (if the organization is registered user/member) to their portal, or alternatively, via email, push notification, SMS text message, mail, and/or any other electronic notification methods. In addition, an organization can have an account with the ability to upload data and certificates to a user's accounts with or without their request. For example, if the organization is a certification institution, once a contractor has completed or obtained one or more certifications, an administrator of the institution can use the contractor's name and unique identifying number or information related to identifying them within the system and upload and attach the data and certificate to the user's account, at which point it is verified because the system recognizes it was uploaded by a third party, in this case the certification institution's account.

Here, once the organization is notified of the credentials update and verification is request, then the process can move to step 462. At 462, the process can obtain or receive from the organization a verification, rejection, verification in part, or rejection in part pertaining to one or more credentials data from module 412.

If the user/contractor selects the managing job record module 430, then the user will be allowed to add, delete, and/or edit their job record or prior/current employment data, wherein the employment or job data can include but is not limited to: non-productive time (NPT), non-productive time (NPT) percentage, actual NPT, estimated NPT, projected NPT, real-time NPT tracking, on-site NPT, off-site NPT, total job man hours, total job time, past or current employment positions, employer(s), job(s), site(s), duties, assignments, contracts, dates of employment, completed/incomplete jobs, type of job, as part-time or full-time contractor or employee, description of the duty/position/job, names of managers/officers/co-workers, tools used or experienced in for that position/job, or the like.

At step 432, the process will determine if the job record module 430 has been updated/modified. If it has not been updated/modified, then at step 434 the process will redirect the user to the job record module 430 or contractor portal 400. At step 432, if the user did update/modify their job time/NPT time data, then at step 436 the performance scoring network process will at step 438 automatically notify one or more employers of the user (contractor/company) to verify if the user did indeed work for that employer for that particular position, job, contract, assignment, title, description, and/or dates. Specifically, within job record module 430, the user can add a specific job/position or duty completed and the employer who hired the user for that particular position/job and further add the start and end date for that position/job and also include the operation time. In addition, the user can enter any non-productive time (NPT), actual NPT, estimated NP, percentage NPT, projected NPT, observed NPT, logged NPT, on-site NPT, off-site NPT, and/or real-time NPT for the particular assignment or job. Here, the user can also insert comments pertaining to the NPT for that particular assignment or job. The user can also request an employer to additionally verify or confirm the NPT with the employer's observed or logged NPT for that particular job or assignment.

Once one or more particular position/job/NPT/assignment(s) for one or more employers have been submitted, the performance scoring network process will determine if the user's job record or NPT data has been updated at step 432, then at step 436 the process can automatically send a notification (via email, push notification, SMS text message, or the like) at step 438 to the employer who hired/employed or is employing the user for that position/job in order to seek verification/approval from the employer for the user's employment and NPT data pertinent to that employer. Once the employer notification has been sent seeking verification from the employer, the process can then proceed to step 440, wherein the process can receive employer verification, rejection, verification in part, rejection in part, add, delete, or modify employment data or NPT data. Here, at step 441, if the employer did not input, add, delete, modify, or update employment or NPT data, then the process can proceed at step 442 to scoring algorithm 420. In this scenario, it can also be assumed that the employer verified the user provided employment or NPT data “as-is”. Alternatively, at step 441, if the employer did indeed input, add, delete, modify, or update employment or NPT data of one or more contractors for one or more jobs, assignments, contracts, or duties, then the process can proceed at step 443 to step 444. In addition, the employer may have the option to add additional feedback or comments. At step 444, the user/contractor can be notified that the employer has made changes to the employment or NPT data. Here, the user/contractor has the option accept the employer made changes, or add, delete, or modify the employer made changes to the employment or NPT data. At step 445, the process will determine if the user/contractor has made any modifications to the employer provided employment or NPT data. Here, if the user/contractor makes no changes, then the process proceeds at step 446 to scoring algorithm 420. In this scenario, it is assumed that the user/contractor has verified or approved the employer provided/modified employment or NPT data “as-is”. Alternatively, if the user/contractor does make changes to the employer provided employment or NPT data, then the process at step 447 can send the updated/modified user provided employment or NPT data back to the employer for verification at step 438.

Here, once the verified employment or NPT data is sent to rating algorithm 420, the rating algorithm will perform calculations, scoring, rating, and grading for the user/contractor, wherein this data will then be sent to the NPT or Efficiency rating console 450 to update NPT or Efficiency rating/score module 452. In addition, during anytime, the user/contractor will be able to view at the contractor portal (such as within job record module 430) the status of an employment/NPT verification request/notification sent to one or more employers. For example, if a verification request has not yet been reviewed or approved/rejected or modified, then a “pending” notification may be displayed to the user/contractor. If an employer has reviewed the request, then the process can display a verified or approved, rejected, denied, verified or approved in part, rejected or denied in part, and/or any or any additional feedback, comments, suggestions, corrections, deletions, additions, or modifications to the employment, NPT, or job data.

In an embodiment of the performance scoring network, scoring algorithm module 420, NPT or performance scoring console or module 450, and NPT or performance scoring module 452 can be used collectively independently of each other. For example, the scoring algorithm 420 can be a part or integrated with module 450. Alternatively, in some embodiments, in lieu of rating algorithm 420, the Performance scoring network can have module 452 conducting calculations, algorithms, ratings, grading, and scoring system/method independent of each other, collectively, or in combination with each other. In one embodiment, scoring algorithm 420 can determine what NPT or performance score the performance scoring network can give to one or more users/contractors registered with the system.

Here, the scores obtained by the scoring algorithm 420, performance score 452 depend on the employment, job, or NPT data obtained from the user/contractor from job record module 430.

In one embodiment, the performance score 452 can be provided as a percentage or numerical score, based on non-productive time as a percentage of actual total job time and also factoring in a predetermined job time.

In other embodiments, any of scores 450 and 452 can be provided as a percentage, score, star, visual pictorial, chart, scale, barometer, text, images to further indicate non-productive time or down time performance, competency, experience, skill, safety, certifications, licensure, knowledge, among others, according to a pre-defined or measurable scale, among others. Here, users, employers, contractors, or operator can customize/configure and specify the criteria for scoring algorithm 420, and/or scores 452, and configure and set a pre-defined or measurable scale to compare their respective configured ratings 452 and thereto. For example, one employer may place heavier weight on how much the NPT is based on the actual job time as a whole and another employer may place heavier weight on how much actual total job time compared to the predetermined total job time for a specific operation.

It is contemplated within the scope of the invention that the scoring algorithm, scoring method, and scoring system of the present invention can use, according to one or more embodiment, can use computer-based methods comprised of sophisticated algorithms, fuzzy logic algorithm, artificial intelligence, machine learning, weighting, certain weights assigned to one or more employment or credential data, computer software, computing systems, mathematical models, advanced programs, electronic databases, analytical tools and experts in economics, job market, job industry, education, credentials, job record, accounting, actuarial processes, statistics, modeling, programming, systems, performance, integration, insurance, legal affairs, government regulations, marketing and sales, administration, management, forecasting and simulation software, non-regression mathematical techniques, trend-based forecasting methods, probability and game theory methods, surveys, and blended techniques, in order to define, model, analyze, calculate, forecast, simulate and/or develop rating, scoring, or grading of employment, non-productive time, experience, performance, credential, competency, reviews, references, skills, qualifications, and the like.

It is further contemplated within the scope of the invention that a user, contractor, employer, or operator can customize, select, designate or incorporate any type of scoring, rating, calculating, or grading method or system can be used for the algorithm rating. For example, a user, employer, or operator can assign more weight to jobs and the type of jobs with respect to the algorithm rating, whereas another user, employer, or operator can assign more weight to credentials and certificates with respect to the algorithm rating. Here, the rating algorithm can factor in the credentials of a contractor, job record, non-productive time, or combination of all or some thereof when calculating a score or rating.

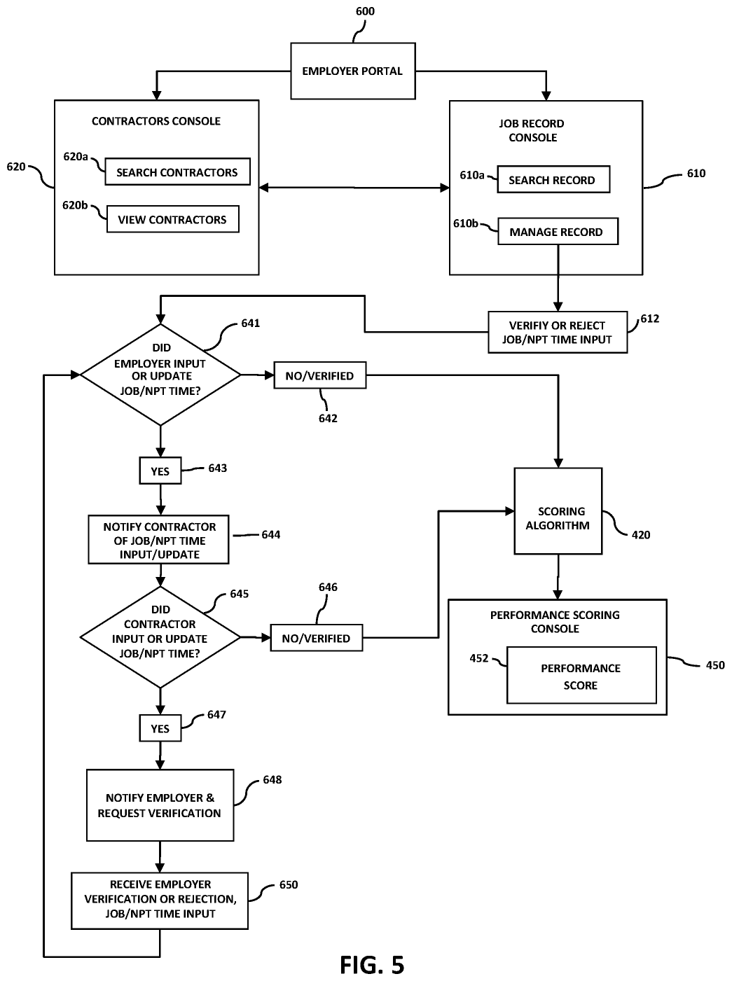

Referring now to FIG. 5, if the user is logged in as an employer, then they will be directed to employer portal 600. At employer portal 600, the user/employer can be provided with a contractor's console or module 620 and job record console or module 610. Contractors console 620 can include a search contractors module 620a and view contractors module 620b, among others. The search contractors module 620a and view contractors module 620b will allow employers to search for any type of contractor or personnel that they may want to hire or employ for a certain position, job, project, assignment, or duty. Here, the employer can search using a variety of search criteria, including but not limited to: non-productive time average; non-productive time for a given period; estimated NPT, projected NPT, actual NPT, logged NPT, non-productive time rating or overall performance score 452; non-productive time for a particular job, assignment, project, or duty; non-productive time for a particular employer; identification number, username, first name, last name, entity name, profile data, grading, rating, score, credentials, personnel, employees, certifications, reviews, employment data, prior experience, prior job, prior duties, prior dates, age, health condition, medical/health assessment, training, credentials, education, medical history, offshore survival, licensure, courses completed, or the like. Further, the user/employer may be able to view a textual or graphical representation of one or more contractors or personnel and can compare the qualifications of one or more contractors. For example, a textual or graphical representation may include a 2-D or 3-D representation, charts, graphs, icons, images, videos, and numerical or visual statistics, such as likelihood of success, job completion, and/or job performance.

Still referring to FIG. 5, if the user/employer selects job record console 610, then they can be provided with search jobs module 610a and manage jobs module 610b. Here, search job module will further allow the user/employer to search and view the job record, NPT data, or employment data of one or more contractors within the performance scoring network database. Manage job module 610b will allow the user/employer to verify or reject at step 612 one or more employment or job data of one or more contractors sent (via notification) to the employer for verification. Specifically, the user/employer will be presented and/or prompted with one or contractors having employment or job data pertinent to the employer. Here, the user/employer can either reject or deny, reject or deny in part, at least partially reject or deny, approve or verify, approve/verify in part, at least partially approve one or more job/NPT time. Further, the user/employer can also modify, provide feedback, such as comments, suggestions, corrections, edits, additions, and/or deletions to the job/NPT time of one or more contractors, wherein the feedback can be sent back to the contractor or contractor admin and such feedback can also be sent to the scoring algorithm 420 for updated calculations, scoring, rating, etc.

More specifically, still referring to FIG. 5, at step 641, if the employer did not input, add, delete, modify, or update job/NPT time, then the process can proceed at step 642 to scoring algorithm 420. In this scenario, it can also be assumed that the employer verified the contractor provided employment time or NPT data “as-is”. Alternatively, at step 641, if the employer did indeed input, add, delete, modify, or update job/NPT time of one or more contractors for one or more jobs, assignments, contracts, or duties, then the process can proceed at step 643 to step 644. In addition, the employer may have the option to add additional feedback or comments. At step 644, the contractor can be notified that the employer has made changes to the job/NPT time. Here, the contractor has the option accept the employer made changes, or add, delete, or modify the employer made changes to the job/NPT time. At step 645, the process will determine if the contractor has made any modifications to the employer provided job/NPT time. Here, if the contractor makes no changes, then the process can proceed at step 646 to scoring algorithm 420. In this scenario, it is assumed that the user/contractor has verified or approved the employer provided/modified job/NPT time “as-is”. Alternatively, if the user/contractor does make changes to the employer provided job/NPT time, then the process at step 647 can send the updated/modified contractor provided job time or NPT time back to the employer for verification at step 648. At step 648, the process can automatically send a notification (via email, push notification, SMS text message, or the like) at step to the employer in order to seek re-verification/approval from the employer for the contractor's job/NPT time pertinent to that employer, similar to the process disclosed with respect to FIG. 4. Once the employer notification has been sent seeking verification from the employer, the process can then proceed to step 650, wherein the process can receive employer verification, rejection, verification in part, rejection in part, add, delete, or modify job/NPT time.

Here, once the verified job/NPT time is sent to scoring algorithm 420, the rating algorithm will perform calculations, scoring, rating, and grading for the user/contractor, wherein this data will then be sent to the performance scoring console 450 to update performance score 452.

Still referring to FIG. 5, in another embodiment, the employer, contractor, or operator can also be presented with an evaluation form (not shown), such as a post job or post-employment review or evaluation of one or more contractors. For example, the performance scoring network can transmit and submit this evaluation form to the employer along with the job/NPT time verification or rejection step 612 or in a separate step independent of step 612. Alternatively, the employer portal 600 can present this form in an interactive user interface to the employer/user, such as within job record console 610. Here, in one embodiment, the form can present the employer with a questionnaire related to one or more contractors or personnel for a particular job, credential, or job record. The questionnaire can be one or more ratings based on performance, efficiency, competency, NPT, safety, and/or satisfaction (i.e. scale of 1 to 10, or 1 to 5, or a descriptive scale of Poor/Fair/Good/Excellent), wherein the ratings can be numerical, text, image, or comments based. Further, the score from the evaluation form/questionnaire can be transmitted to score algorithm 420, which can be computed, calculated, and/or integrated with performance scoring module 450 and performance score 452. It is contemplated within the scope of the invention that the aforementioned process for an evaluation form is also applicable for contractor portal 400 (wherein contractor completes evaluation form for itself or one or more contractors), and operator portal 700 (wherein operator completes evaluation form for one or more employer's or contractor's).

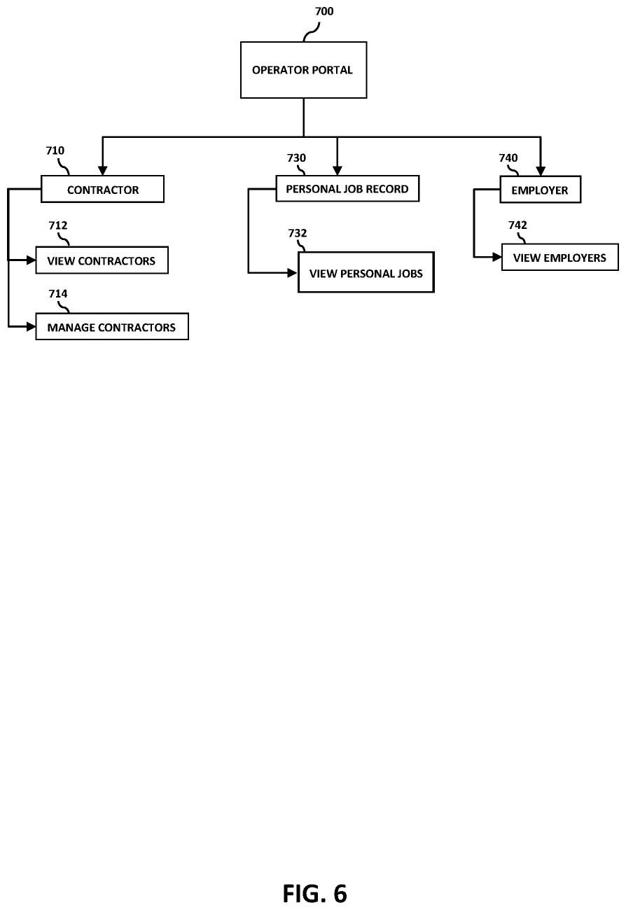

Referring now to FIG. 6, if the user is logged in as an operator, then they will be directed to operator portal 700. At operator portal 700, the user can be presented with one or more modules, such as contractor module 710, personal job record module 730, and employer module 740. It is contemplated within the scope of the invention that the operator portal 700 can include any number of modules for allowing the operator to control various functionalities, settings, user interface, graphical representations, capabilities, and user access levels/privileges for the performance scoring network. Further, the operator portal can also be referred to herein as dashboard, dashboard portal, or dashboard administrator.

Still referring to FIG. 6, contractor module 710 will allow the user/operator to view or search contractors within the performance scoring network database via view contractors module 712. In addition, the user can manage one or more contractors via manage contractors module 714. Specifically, the operator can either add, remove, edit, block, message, notify, or alert contractor users within the performance scoring network. In addition, the operator can request employment verification from their current employing contractor. The job record module 730 will allow the user to search and view personal job records, job data, NPT data, and/or credentials via view personal jobs module 732.

Still referring to FIG. 6, employer module 740 will allow the user/operator to view or search employers within the performance scoring network database via view employer module 742. Specifically, the view employers module 742 will allow the user to search and view one or more employers registered with the performance scoring network. It is further contemplated within the scope of the invention that operator portal 700 can store, manage and/or process payments, fees, subscriptions, royalties, licenses, documents, photos, videos, multimedia for one or more of users, contractors, contractor admins, non-members, and employers.

It is contemplated within the scope of the present invention that the performance scoring network of the present invention can be a social network or electronic forum wherein user can communicate and interact with other. In addition, the performance scoring network can a stand-alone system or integrated with or associated with another social network. For example, the performance scoring network can be integrated with or operate in tandem with social and employment networks such as Facebook®, Google+®, and/or LinkedIn®. In addition, user profiles and user data of users from another or third-party social network can be populated, integrated, linked, or associated with the performance scoring network.

It is contemplated within the scope of the invention that any performance scoring algorithm 420, performance score 452 can be presented to either the employer, contractor, operator, or related users in either a real numerical value, time increments (second, minutes, hours, days, months, years), whole values, fractional values, percentages, visual indicators, graphs, charts, images, video, or audio.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts described herein, except insofar as such limitations are included in the following claims. Further, it will be understood that certain features and sub-combinations are of utility and may be employed without reference to other features and sub-combinations.

What is claimed is:

1. A method for scoring contractor performance, the method comprising:
projecting total time of a service contractor operation;
receiving actual total time of said service contractor operation;
verification of actual total time of said service contractor operation;
receiving actual total non-productive time of said service contractor operation;
verification of actual total non-productive time of said service contractor operation; and
calculating a score for said service contractor operation.

2. The method of claim 1, wherein the projected total time of a service contractor operation is predetermined.

3. The method of claim 1, wherein verification of actual total time of said service contractor operation is mutually agreed upon.

4. The method of claim 1, wherein verification of actual total non-productive time of said service contractor operation is mutually agreed upon.

5. The method of claim 1, wherein time is comprised of one or more: seconds, minutes, hours, days, months, and years.

6. The method of claim 1, wherein the calculated score is comprised of: projected total time of a service contractor operation, verified actual total time of said contractor operation, and verified actual total non-productive time of said contractor operation.

7. The method of claim 1, wherein the calculated score is further comprised of one or more: rating, value, percentage, efficiency, and numerical value.

8. A non-transitory computer readable medium that stores a program that causes a computer to score contractor performance, the program comprising:
projecting total time of a service contractor operation;
receiving actual total time of said service contractor operation;
verification of actual total time of said service contractor operation;
receiving actual total non-productive time of said service contractor operation;
verification of actual total non-productive time of said service contractor operation; and
calculating a score for said service contractor operation.

9. The program of claim 8, wherein the projected total time of a service contractor operation is predetermined.

10. The program of claim 8, wherein verification of actual total time of said service contractor operation is mutually agreed upon.

11. The program of claim 8, wherein verification of actual total non-productive time of said service contractor operation is mutually agreed upon.

12. The program of claim 8, wherein time is comprised of one or more: seconds, minutes, hours, days, months, and years.

13. The program of claim 8, wherein the calculated score is comprised of: projected total time of a service contractor operation, verified actual total time of said contractor operation, and verified actual total non-productive time of said contractor operation.

14. The program of claim 8, wherein the calculated score is further comprised of one or more: rating, value, percentage, efficiency, and numerical value.
